(19) United States
(12) Patent Application Publication
(10) Pub. No.: US 2012/0194070 A1
(43) Pub. Date: Aug. 2, 2012

(54) OPERATING AN ELECTRODELESS DISCHARGE LAMP

(75) Inventor: Haimin Tao, Eindhoven (NL)

(73) Assignee: KONINKLIJKE PHILIPS ELECTRONICS N.V., EINDHOVEN (NL)

(21) Appl. No.: 13/394,961

(22) PCT Filed: Sep. 3, 2010
(86) PCT No.: PCT/IB2010/053966

§ 371 Date: Mar. 8, 2012

(30) Foreign Application Priority Data
Sep. 9, 2009 (EP) 09169827.4

(51) Int. Cl. H05B 41/24

(52) U.S. Cl. 315/34

(57) ABSTRACT

A power driver circuit for an electrodeless discharge lamp comprises a push- pull class E converter comprising power supply terminals for receiving a DC supply voltage, and lamp output terminals for supplying power to an antenna of the lamp. The converter has a first switching leg and a second switching leg arranged in parallel between the power supply terminals. The first switching leg has a series arrangement of a first switching element and a first driver circuit inductor having a common first node. The second switching leg has a series arrangement of a second switching element and a second driver circuit inductor having a common second node. The lamp output terminals are coupled between the first node and the second node. A lamp impedance matching network is coupled between the first node and the second node, wherein the impedance matching network comprises at least one series resonant capacitor coupled in series with the lamp output terminals. A starting circuit comprises a series arrangement of a starting inductor and a starting capacitor coupled between a first starting circuit terminal and a second starting circuit terminal. The first starting circuit terminal is coupled between the first switching element of the power driver circuit and a first lamp output terminal. A node coupling the starting inductor and the starting capacitor is configured to be coupled to an ignition appendix of the lamp. A gate drive circuit is configured to supply a near-sinusoidal gate drive current.

### FIELD OF THE INVENTION

The invention relates to the field of lighting, and more specifically to circuits for operating an electrodeless discharge lamp.

### BACKGROUND OF THE INVENTION

In developments in the field of lighting, high efficacy is one of the main driving forces. Inductively coupled electrodeless discharge lamps (also referred to as electrodeless fluorescent lamps, EFLs, or electrodeless high intensity discharge, HID, lamps) have the potential to reach high efficiency at high powers.

Electrodeless discharge lamps usually comprise an antenna and a discharge vessel. The antenna is fed with a high frequency (radio frequency, RF) current. Efficient power generation for driving an electrodeless discharge lamp is offered by power driver circuits having a switching-mode operation of RF power converters, for example, having class E operation. The class E operation can eliminate a transistor turn-on loss and can incorporate an intrinsic transistor output capacitor into the converter circuit. An example of a push-pull class E amplifier to drive an electrodeless discharge lamp is described in reference U.S. Pat. No. 5,387,850.

Electrodeless lamps represent highly inductive loads which lead to a high quality factor. Therefore, in order for the power driver circuit to be able to deliver sufficient active power to the load, an impedance matching network is necessary to match the highly inductive electrodeless lamp load to an optimum impedance expected by the power driver circuit. RF power driver circuits are usually designed for 50 Ohm standard load matching, which is convenient for measurements and cabling. However, for driving an electrodeless lamp, it is not necessary an advantage.

Since electrodeless discharge lamps, e.g. electrodeless high intensity gas discharge lamps, have no electrodes, ignition aids must be provided in order to initiate a main discharge. In the past, various circuit arrangements have been proposed, e.g. using a separate RF supply dedicated for ignition, or connecting a series resonant LC starting circuit to the antenna of the electrodeless discharge lamp, or using a passive series resonant LC circuit or a passive parallel resonant LC circuit. In all of these circuit arrangements, a class D RF power driver circuit was used. By way of example, reference is made to U.S. Pat. No. 5,057,750.

Basically, a class E amplifier can achieve high efficiency at very high switching frequencies of the switching devices, usually embodied as field effect transistors, FETs. Besides a drain loss of the amplifier, a gate drive loss is an important part of the total loss, and can even be overwhelming. Therefore, reducing the gate drive loss is an important step toward an efficient RF driver circuit. Resonant gate drivers use resonance to partly recover the energy in the gate of the switching device. However, resonant gate drivers may even become less efficient than the conventional gate driver at frequencies beyond 10 MHz, since the gate drive loss increases dramatically at higher frequencies. Besides this, precise timing control of the gate switches also becomes increasingly difficult. For very high frequencies, methods for driving the switching devices with a sinusoidal voltage, instead of a square-wave voltage, have been investigated. However, the operating principles need to be changed to be able to cope with very high frequencies.

### SUMMARY OF THE INVENTION

It would be desirable to provide a simple power driver circuit for an electrodeless discharge lamp. It would also be desirable to provide a power driver circuit for an electrodeless discharge lamp with improved efficiency. It would further be desirable to provide a power driver circuit for an electrodeless discharge lamp producing a reduced electromagnetic interference, EMI. It would still further be desirable to provide a power driver circuit for an electrodeless discharge lamp having reduced costs.

To better address one or more of these concerns, in a first aspect of the invention a power driver circuit for an electrodeless discharge lamp is provided. The power driver circuit comprises a push-pull class E converter comprising power supply terminals for receiving a DC supply voltage, and lamp output terminals for supplying power to an antenna of the lamp. The converter further comprises a first switching leg and a second switching leg arranged in parallel between the power supply terminals, the first switching leg comprising a series arrangement of a first switching element and a first driver circuit inductor having a common first node, and the second switching leg comprising a series arrangement of a second switching element and a second driver circuit inductor having a common second node. The lamp output terminals are coupled between the first node and the second node. A lamp impedance matching network is coupled between the first node and the second node, wherein the impedance matching network comprises at least one series resonant capacitor coupled in series with the lamp output terminals.

In a second aspect of the invention, a starting circuit is provided, in particular for use in the power driver circuit of the present invention, but also for other power driver circuits for electrodeless discharge lamps. The starting circuit comprises a series arrangement of a starting inductor and a starting capacitor coupled between a first starting circuit terminal and a second starting circuit terminal. The first starting circuit terminal is coupled between the first switching element of the power driver circuit and a first lamp output terminal. A node coupling the starting inductor and the starting capacitor is configured to be coupled to an ignition appendix of the lamp.

In a third aspect of the invention, a gate drive circuit for a MOSFET is provided, in particular for use in the power driver circuit of the present invention, wherein each one of the first switching element and the second switching element is a MOSFET having a gate coupled to a gate drive circuit, but also for other power driver circuits for electrodeless discharge lamps having MOSFET switching elements being switched at very high frequencies. The gate drive circuit comprises a series arrangement of a gate drive inductor and a gate drive capacitor coupled between a first gate drive circuit terminal and a second gate drive circuit terminal. The first gate drive circuit terminal is coupled to the gate of the MOSFET. A first gate drive switch is coupled between the first gate drive circuit terminal and the second gate drive circuit terminal, and a second gate drive switch is coupled between the first gate drive circuit terminal and a DC power supply. The gate drive circuit further comprises a gate drive switch control circuit for controlling the switching of the first gate drive switch and the second gate drive switch, the gate drive switch control circuit being configured to switch the first gate drive switch and the second gate drive switch each on with a phase difference of 180 degrees and with a duty cycle of between about 0.1 and about 0.3.

In a fourth aspect of the invention, a lighting unit is provided. The lighting unit comprises a power driver circuit of the present invention, and an electrodeless lamp comprising an antenna winding having antenna terminals. The lamp output terminals of the power driver circuit are connected to the antenna terminals of the lamp.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 schematically depicts an embodiment of an electrodeless discharge lamp.

FIG. 2 depicts a system block diagram of a power supply circuit including a power driver circuit according to the present invention, for driving an electrodeless discharge lamp.

FIG. 3 depicts a first embodiment of a power factor correction, PFC, circuit usable in the power supply circuit of FIG. 2.

FIG. 4 depicts a second embodiment of a power factor correction, PFC, circuit usable in the power supply circuit of FIG. 2.

FIG. 5 depicts a third embodiment of a power factor correction, PFC, circuit usable in the power supply circuit of FIG. 2.

FIG. 6 depicts a circuit diagram of an embodiment of a push-pull class E converter according to the present invention.

FIGS. 7a, 7b, 7c and 7d depict different circuit diagrams of impedance matching networks for use in embodiments of a power driver circuit according to the present invention driving an electrodeless (inductively coupled) discharge lamp.

FIG. 8 depicts a further circuit diagram of a symmetrical impedance matching network for use in an embodiment of a power driver circuit according to the present invention driving an electrodeless discharge lamp.

FIG. 9 depicts a circuit diagram of a class E load network coupled to ideal switches.

FIG. 10 depicts the circuit diagram of FIG. 9 for illustration of a distribution of capacitances.

FIG. 11 depicts the circuit diagram of FIG. 9 with a class E load network coupled to real switches.

FIG. 12 depicts a variant of the circuit diagram of FIG. 11.

FIG. 13 depicts the circuit diagram of FIG. 6 in more detail.

FIG. 14 depicts voltages and current in the circuit diagram of FIG. 13 in operation, in particular drain voltages of the MOSFET switches, and an output lamp current.

FIG. 15 depicts the circuit diagram of FIG. 13, supplemented with a lamp starting circuit.

FIG. 16 depicts a circuit diagram of an embodiment of a lamp starting circuit.

FIG. 17 depicts a power driver circuit for an electrodeless lamp, including an embodiment of a lamp starting circuit.

FIG. 18 depicts a variant of a power driver circuit for an electrodeless lamp, including an embodiment of a lamp starting circuit.

FIG. 19 depicts a further variant of a power driver circuit for an electrodeless lamp, including an embodiment of a lamp starting circuit.

FIG. 20 depicts a still further variant of a power driver circuit for an electrodeless lamp, including an embodiment of a lamp starting circuit.

FIG. 21 depicts another variant of a power driver circuit for an electrodeless lamp, including an embodiment of a lamp starting circuit.

FIG. 22 depicts a single-ended variant of a power driver circuit for an electrodeless lamp, including an embodiment of a lamp starting circuit.

FIG. 23 illustrates timing charts of voltage, currents, power, efficiency and frequency in a power driver circuit in operation.

FIG. 24 depicts a further variant of a power driver circuit for an electrodeless lamp, including an embodiment of a lamp starting circuit.

FIG. 25 illustrates a timing chart of an operating frequency of the power driver circuit of FIG. 24.

FIG. 26 depicts a circuit diagram of an embodiment of an existing gate drive circuit.

FIG. 27 illustrates control of, and waveforms of current and voltage occurring in the gate drive circuit of FIG. 26 in operation.

FIG. 28 depicts a circuit diagram of an embodiment of a gate drive circuit, also illustrating parasitic elements of a MOSFET switch.

FIG. 29 illustrates timing charts of control of, and waveforms of current and voltage occurring in the gate drive circuit of FIG. 28 in operation.

FIG. 30 depicts a circuit diagram of a further embodiment of a gate drive circuit, also illustrating parasitic elements of a MOSFET switch.

FIG. 31 illustrates a timing chart of a waveform of voltage occurring in the gate drive circuit of FIG. 30 in operation.

FIG. 32 depicts a block and circuit diagram illustrating a logic circuit for control of an embodiment of a gate drive circuits, which in turn control switches of a power driver circuit.

### DETAILED DESCRIPTION OF EMBODIMENTS

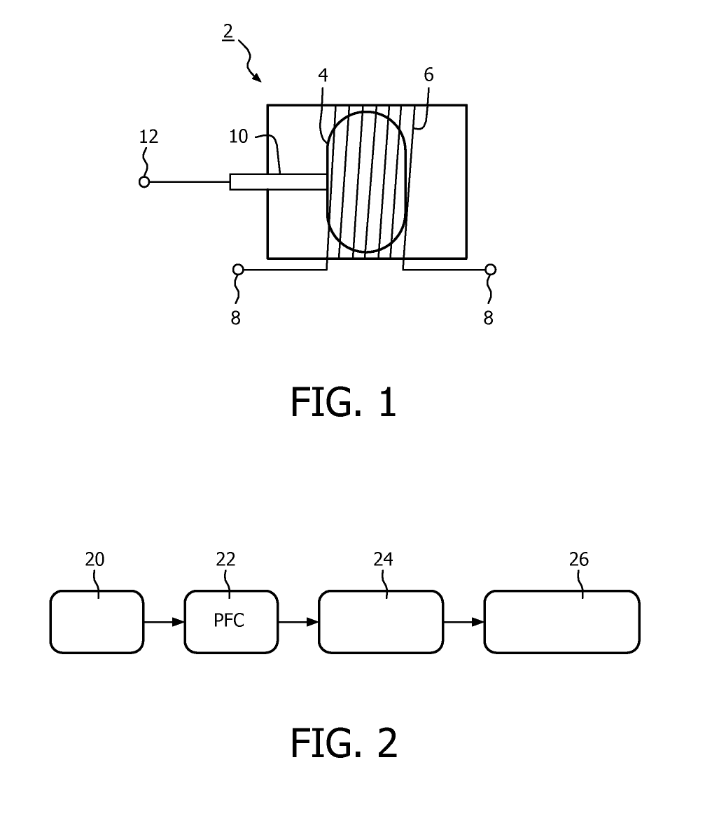

FIG. 1 schematically shows an inductive high intensity discharge, HID, lamp 2 as an example of an electrodeless discharge, ED, lamp. The ED lamp 2, having a support structure 3, comprises a discharge vessel 4 and an antenna 6, also referred to as coupling coil, consisting of one or more turns of an electrical conductor wound around the discharge vessel. The antenna 6 has antenna terminals 8 for supplying an alternating high frequency current to the antenna 6. The supply current frequency may be selected in the Industrial-Scientific-Medical (ISM) bands (e.g., 13.56 MHz) because of the high emission limits allowed by the governing bodies. To facilitate the ignition of the ED lamp 2, an ignition appendix 10 is added to the lamp construction and is attached to an outer surface of the discharge vessel 4. The ignition appendix 10 is filled with a relatively low-pressure gas and is therefore easily ignitable through an ignition terminal 12. The ignition appendix 10 acts as a conductor after ignition, providing a conduction path for electrons and consequently enabling an ignition of a main discharge in the discharge vessel 4.

FIG. 2 schematically shows a mains supply 20 supplying AC (e.g., 50 or 60 Hz) or DC electrical power. As symbolized by an arrow, the mains supply 20 is coupled to a power factor correction, PFC, circuit 22. The PFC circuit 22 converts the electrical power received at its input from the mains supply 20 into DC power supplied at its output, while filtering and correcting the power factor of the input current. As symbolized by a further arrow, the PFC circuit 22 is coupled to a power driver circuit embodied as a class E radio frequency, RF, converter 24. The RF converter 24, which is discussed in more detail below, converts the DC power received at its input from the PFC circuit 22 into RF power supplied at its output. As symbolized by a further arrow, the RF converter 24 is coupled to an electrodeless discharge, ED, lamp 26 (of the type discussed above by reference to FIG. 1). The ED lamp 26 converts the RF power received at its antenna terminals into visible light.

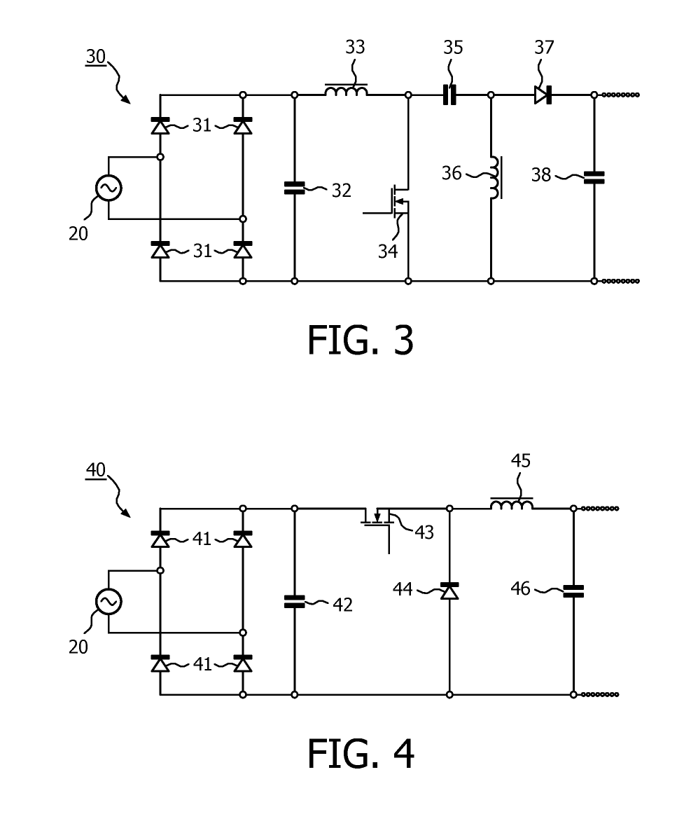

FIG. 3 illustrates an embodiment of a PFC circuit as presented with reference to FIG. 2, and embodied as a single ended primary inductor converter, SEPIC, 30. The SEPIC 30 is coupled to a mains supply 20, and comprises a full bridge rectifier comprising four diodes 31, and connected in parallel to a first capacitor 32. A series arrangement of a first inductor 33 and a field effect transistor, FET, switch 34 is connected in parallel to the first capacitor 32, with the first inductor 33 connected to a common node of the cathodes of two diodes 31, and the first capacitor 32, and with the drain of the FET switch 34 connected to the first inductor 33. A series arrangement of a second capacitor 35 and a second inductor 36 is connected in parallel to the FET switch 34, with the second capacitor 35 connected to a common node of the first inductor 33 and the drain of the FET switch 34. A series arrangement of a fifth diode 37 and a third capacitor 38 is connected in parallel to the second inductor 36, with the anode of the fifth diode 37 connected to a common node of the second capacitor 35 and the second inductor 36. The first inductor 33 and the second inductor 36 may be integrated as a coupled inductor. In operation, while switching the FET switch 34 on and off in a proper timing sequence, the SEPIC 30 supplies a DC output through the terminals of the third capacitor 38.

FIG. 4 illustrates a further embodiment of a PFC circuit as presented with reference to FIG. 2, and embodied as a buck converter 40. The buck converter 40 is coupled to a mains supply 20, and comprises a full bridge rectifier comprising four diodes 41, and connected in parallel to a first capacitor 42. A series arrangement of a field effect transistor, FET, switch 43 and a fifth diode 44 is connected in parallel to the first capacitor 42, with the drain of the FET switch 43 connected to a common node of the cathodes of two diodes 41, and the first capacitor 42. The fifth diode 44 has its cathode connected to the source of the FET switch 43. A series arrangement of a first inductor 45 and a second capacitor 46 is connected in parallel to the fifth diode 44, with the first inductor 45 connected to a common node of the source of the FET switch 43 and the cathode of the fifth diode 44. In operation, while switching the FET switch 43 on and off in a proper timing sequence, the buck converter 40 supplies a DC output through the terminals of the second capacitor 46.

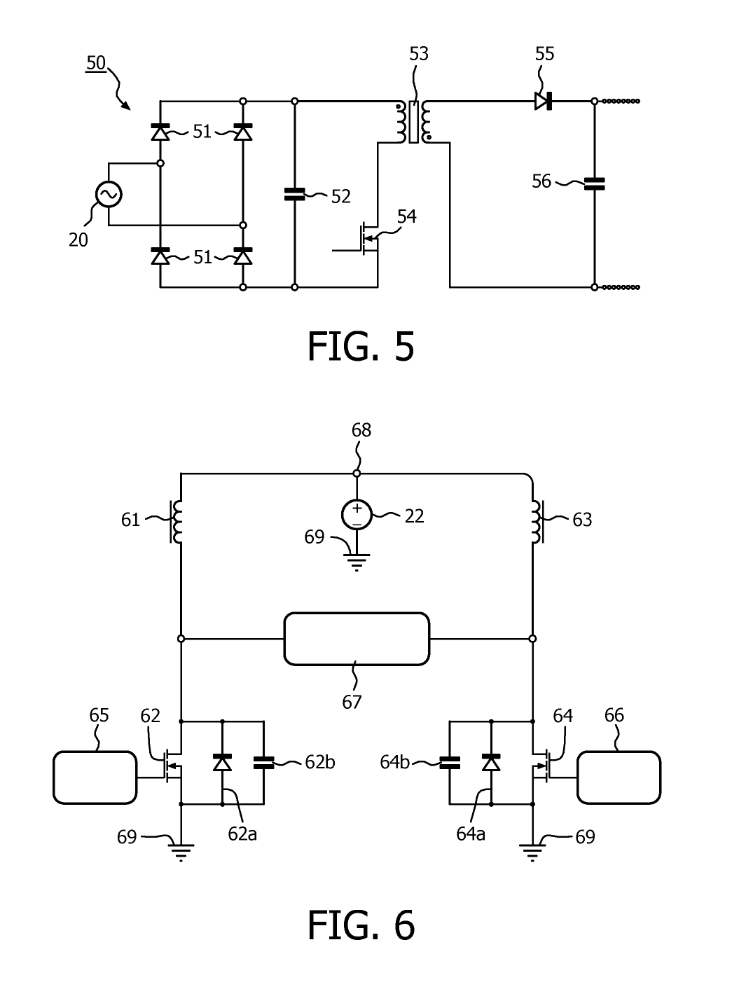

FIG. 5 illustrates a further embodiment of a PFC circuit as presented with reference to FIG. 2, and embodied as a flyback converter 50. The flyback converter 50 is coupled to a mains supply 20, and comprises a full bridge rectifier comprising four diodes 51, and connected in parallel to a first capacitor 52. A series arrangement of a primary winding of a transformer 53, and a field effect transistor, FET, switch 54 is connected in parallel to the first capacitor 52, with the primary winding of the transformer 53 connected to a common node of the cathodes of two diodes 51, and the first capacitor 52. The FET switch 54 has its drain connected to the primary winding of the transformer 53. A series arrangement of a fifth diode 55 and a second capacitor 56 is connected in parallel to a secondary winding of the transformer 53, with the cathode of the fifth diode 55 connected to the second capacitor 56. In operation, while switching the FET switch 54 on and off in a proper timing sequence, the flyback converter 50 supplies a DC output through the terminals of the second capacitor 56.

It is noted here that the PFC circuit as presented with reference to FIG. 2 may take other embodiments than the SEPIC 30, the buck converter 40 or the flyback converter 50, which are presented as exemplary embodiments only.

FIG. 6 shows the class E RF converter 24 (as shown in FIG. 2), coupled to a PFC circuit 22 shown schematically as a DC power supply, in more detail. The converter 24 is a push-pull type converter having two switching legs supplied by the PFC circuit 22 through power supply terminals 68, 69. A first switching leg comprises an first inductor 61 (DC choke) coupled in series to a metal oxide semiconductor field effect transistor,

MOSFET, 62. A second switching leg comprises a second inductor 63 (DC choke) coupled in series to a MOSFET 64. The first and the second switching legs are coupled in parallel to the PFC circuit 22. In FIG. 6, the MOSFETs 62 and 64 are shown with their intrinsic diodes 62a and 64a, respectively, and with their intrinsic output capacitors 62b and 64b, respectively. Each of the MOSFETs 62, 64 is controlled by a resonant gate driver 65, 66, respectively, to be discussed below in more detail. Between the drains of the MOSFETs 62, 64, a load (lamp) impedance matching network and an ED lamp are connected, as indicated by block 67, and to be discussed below in more detail. The impedance matching network is coupled to lamp output terminals, between which the antenna terminals of an ED lamp can be connected.

Gate drive signals for the MOSFETs 62, 64 generated by the resonant gate drivers 65, 66 are phase-shifted with respect to each other by 180 degrees. For the push-pull class E converter 24, the odd harmonic voltage components of each switching leg are equal in amplitude but opposite in phase, whereas the even harmonic voltage components are equal both in amplitude and phase. Because of the push-pull symmetrical operation of the converter 24, the differential voltage across the drains of the MOSFETs 62, 64 contains only odd harmonics. When sufficient care is taken in designing a printed circuit board, PCB, layout of the converter 24, keeping the physical circuit arrangement as symmetrical as possible, the electromagnetic interference, EMI, of the converter is low.

Different from standard RF amplifier design, the output of the class E converter 24 is not matched to a standard 50 Ohm RF load. Instead, the power driver circuit directly drives the lamp without any external matching box. This saves components, and therefore also saves costs.

The coupling coil of the ED lamp usually only has a few turns in order to achieve the best coupling efficiency. The impedance matching network transforms the impedance of the ED lamp load to an optimum class E impedance.

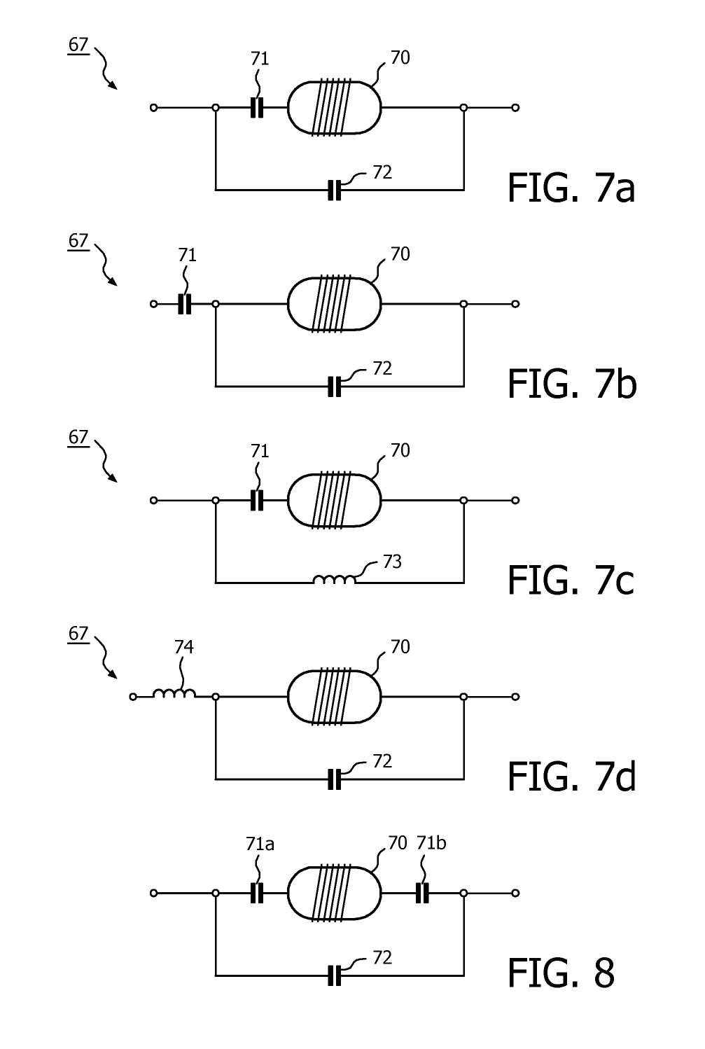

As illustrated in FIGS. 7a, 7b, 7c and 7d, respectively, in general four circuits of an impedance matching network are possible. In the embodiment of FIG. 7a, block 67 (see FIG. 6) is shown as comprising an ED lamp 70 connected in series to a series resonant capacitor 71, where the series arrangement of the ED lamp 70 and series resonant capacitor 71 is connected in parallel to a differential capacitor 72. In the embodiment of FIG. 7b, block 67 is shown as comprising the ED lamp 70 connected in parallel to the differential capacitor 72, where the parallel arrangement of the ED lamp 70 and the differential capacitor 72 is connected in series to the series resonant capacitor 71. In the embodiment of FIG. 7c, block 67 is shown as comprising the ED lamp 70 connected in series to the series resonant capacitor 71, where the series arrangement of the ED lamp 70 and the series resonant capacitor 71 is connected in parallel to a differential inductor 73. In the embodiment of FIG. 7d, block 67 is shown as comprising the ED lamp 70 connected in parallel to the differential capacitor 72, where the parallel arrangement of the ED lamp 70 and the differential capacitor 72 is connected in series to a series resonant inductor 74.

In the networks illustrated in FIGS. 7a, 7b, 7c and 7d, the use of an inductor (or a transformer or any other inductive element), as shown in FIGS. 7c and 7d, is less preferred in view of the component size, weight and cost. Because the ED lamp 70 itself is a highly inductive load, the use of capacitors only, as shown in FIGS. 7a and 7b, is more preferred. Out of the two configurations shown in FIGS. 7a and 7b, the series-parallel arrangement of FIG. 7a potentially offers a wider zero voltage switching, ZVS, operating range, and allows for a higher capacitance of the MOSFET output capacitor 62b, 64b (FIG. 6). For a given ED lamp impedance (highly inductive), with simple calculations it is possible to determine the capacitance values of the series resonant capacitor 71 and the differential capacitor 72.

In fact, the network of FIG. 7a is the only impedance matching network that allows for the differential capacitor 72 to be absorbed by the MOSFET output capacitor 62b, 64b. This is explained with reference to FIG. 8.

The impedance matching network of FIG. 8 corresponds with the impedance matching network of FIG. 7a, however, in order to keep a symmetry of the impedance matching network, the series resonant capacitor 71 is arranged as two capacitors 71a and 71b in series with the ED lamp 70. If the capacitance of the series resonant capacitor 71 is Cₛ, the capacitance of series resonant capacitor 71a is Cₛ₁, and the capacitance of series resonant capacitor 71b is Cₛ₂, the following relationship exists: Cₛ₁=Cₛ₂=2·Cₛ. It is observed that in practice each capacitor can be implemented with a combination of series and parallel arrangements of several capacitors to obtain a desired capacitance and voltage rating. The series resonant capacitors 71a and 71b operate in a series resonance with the ED lamp 70, which produces a high voltage across the ED lamp antenna because of the high quality factor of the resonant tank, which facilitates the ignition of the ED lamp 70.

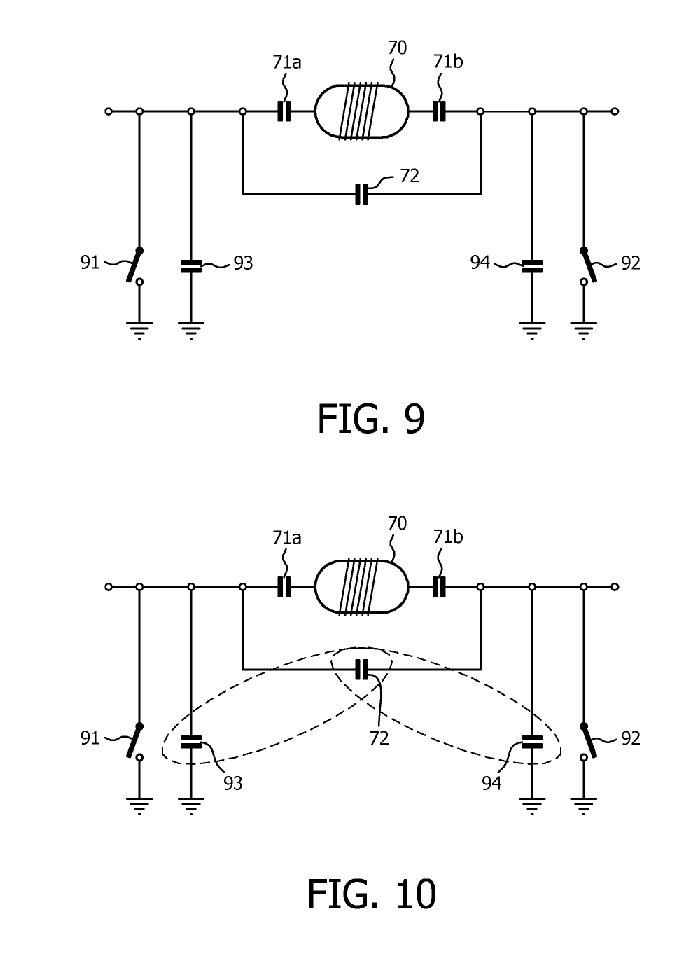

Referring to FIG. 9, in a further analysis of the class E converter load network, initially it will be assumed that the MOSFETs 62 and 64 (see FIG. 6) behave like ideal switches 91 and 92, respectively. As required for class E operation, parallel (shunt) capacitors 93 and 94, each having a capacitance Cₚ, are connected across the switches 91 and 92, respectively.

It is known that a silicon based power switch such as a power MOSFET has a relatively large intrinsic capacitance, dependent on the chip die area. When operating at a very high (radio) frequency, this intrinsic (or parasitic) capacitor of a real embodiment of a switch is an important component.

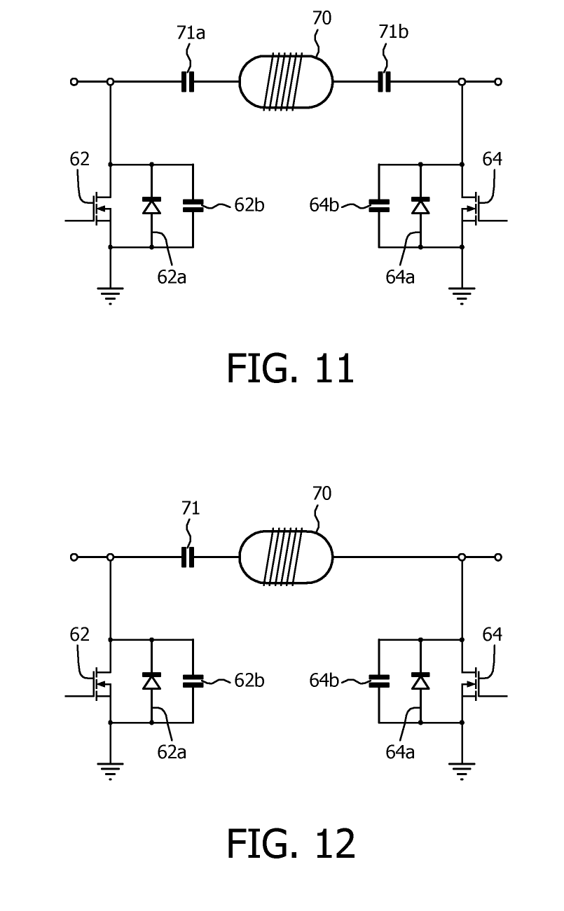

As illustrated in FIGS. 10 and 11, starting from the proposed impedance matching network of FIG. 8, both the parallel capacitors 93 and 94, and the differential capacitor 72, having a capacitance C_{d}, can be absorbed by the respective MOSFET output capacitors 62b, 64b (see FIG. 6) each having a capacitance Cₒₛₛ. This is indicated in FIG. 10 by dashed ellipses. In an extreme case, therefore, the only components in the impedance matching network are the series resonant capacitors 71a and 71b (see FIG. 11), which reduces the parts count in the load network to a minimum. Accordingly, the MOSFETs are optimally designed or selected such that Cₒₛₛ≦C_{d}+Cₚ. When Cₒₛₛ=C_{d}+Cₚ, the differential capacitor 72 and the parallel capacitors 93 and 94 may be omitted, whereas when Cₚ<Cₒₛₛ<C_{d}+Cₚ, the parallel capacitors 93 and 94 may be omitted, but the differential capacitor 72 remains in the circuit. Furthermore, when Cₒₛₛ<Cₚ, the parallel capacitors 93 and 94 may be omitted, and the differential capacitor 72 remains in the circuit having a capacitance of (Cₚ−Cₒₛₛ+C_{d}).

It is noted that Cₒₛₛ should be understood as an equivalent value of the MOSFET output capacitance, since the MOSFET output capacitors 62b, 64b are non-linear. This is the limit for the allowable chip area of the MOSFET for class E operation. The non-linearity of the output capacitance of the MOSFET should be restricted to be able to achieve class E operating waveforms. As such, a switching device with the lowest allowed ON-resistance R_{DSON} is used. If the class E converter is designed in such a way, a conduction loss of the class E converter is minimized, and a maximum drain efficiency is achieved.

The circuit of FIG. 11 can also be implemented as depicted in FIG. 12, where the capacitance Cₛ of the series resonant capacitor 71 equals half the capacitance Cₛ₁ or Cₛ₂ of a series resonant capacitor 71a or 71b, respectively: Cₛ=0.5·Cₛ₁=0.5·Cₛ₂.

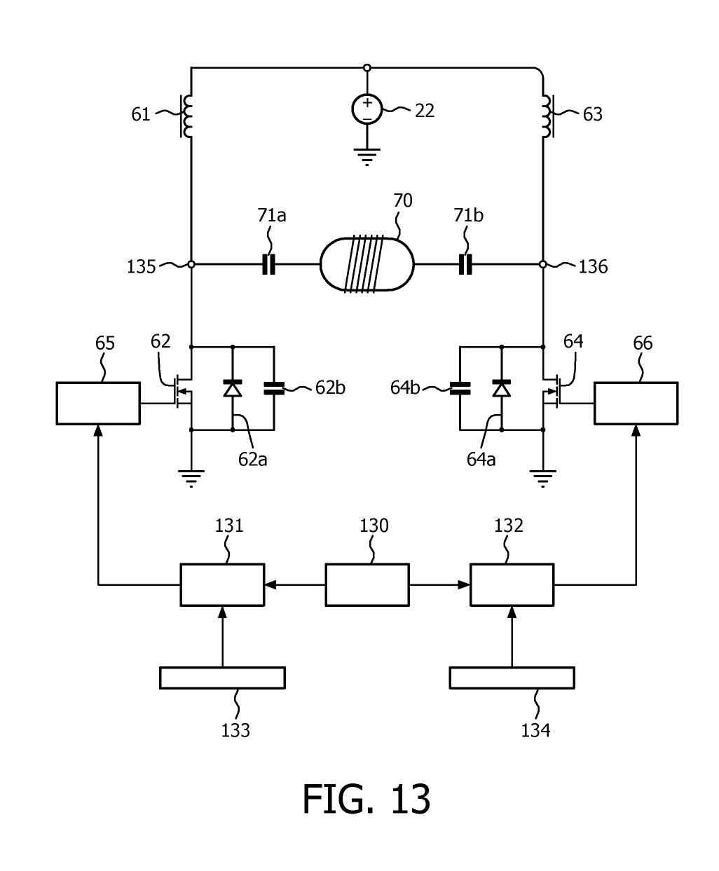

FIG. 13 shows the class E RF converter 24 (as shown in FIG. 6), coupled to a PFC circuit 22 shown schematically as a DC power supply, in more detail. The impedance matching network and an ED lamp, as indicated by block 67 in FIG. 6, are shown to comprise series resonant capacitors 71a, 71b and ED lamp 70. A clock generator 130 generates a clock signal having an RF frequency in one of the ISM bands, e.g. a frequency of 13.56 MHz, and provides a timing control to logic circuits 131 and 132, as indicated by arrows. Logic circuit 131, controlled by a duty cycle control circuit 133, provides a control signal to a gate drive circuit 65. Logic circuit 132, controlled by a duty cycle control circuit 134, provides a control signal to a gate drive circuit 66. The control signal provided by the logic circuit 131 comprises digital pulses with a 180 degrees phase shift with respect to digital pulses comprised in the control signal provided by the logic circuit 132.

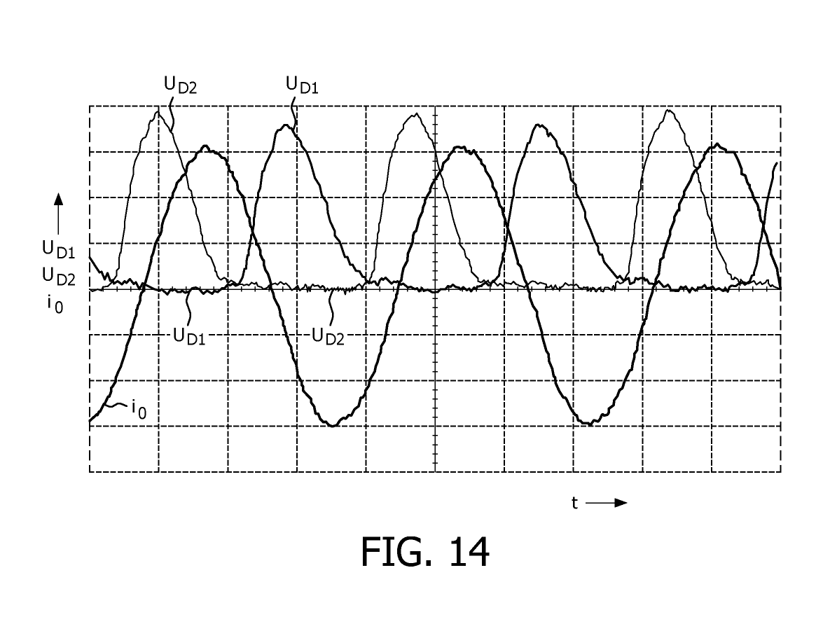

With an arrangement as illustrated in FIG. 13, drain voltages and an output current as shown in the time (t) diagram of FIG. 14 may be obtained. As shown in FIG. 14, a drain voltage u_{D1} at a node 135 (FIG. 13), and a drain voltage u_{D2} at a node 136 (FIG. 13) may be generated, resulting in an output current iₒ. The drain voltages u_{D1} and u_{D2} are very close to an optimum class E waveform. The output current iₒ is nearly sinusoidal, and contains very little harmonics. In practice, a drain efficiency above 93% may be obtained, and an overall class E converter efficiency (also referred to as a power-added efficiency) may approach 90%.

Next, a starting circuit for an electrodeless discharge, ED, lamp 2 will be described.

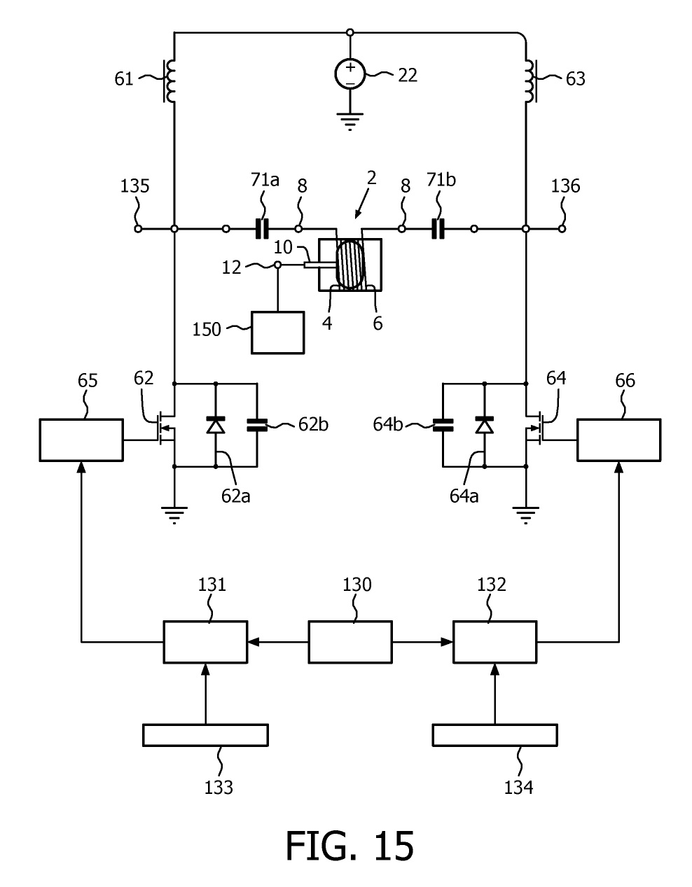

Referring to FIG. 15, an ED lamp 2, comprising a discharge vessel 4, an antenna 6 having antenna terminals 8, and an ignition appendix 10 having an ignition terminal 12, is connected in series to series resonant capacitors 71a, 71b through its antenna terminals 8, and is connected between drains of MOSFETs 62 and 64, each having intrinsic diodes 62a and 64a, and intrinsic output capacitors 62b and 64b, respectively. In a first switching leg supplied by a DC power supply 22, a first inductor 61 is arranged in series to the MOSFET switch 62. In a second switching leg arranged in parallel to the first switching leg, a second inductor 63 is coupled in series to the MOSFET switch 64. The on and off switching of each of the MOSFET switches 62 and 64 is controlled as explained above by reference to FIG. 13. FIG. 15 further shows a starting circuit 150 for starting the operation of the ED lamp 2.

It has been found that the electric field generated by the antenna 6 usually at room temperature is not high enough to initiate the main discharge in the discharge vessel 4. Therefore, ignition aids may be provided. A series resonant ignition has been proven to be a good choice. To ignite an inductive ED lamp, such as an HID lamp, the following conditions must be met. First, a large power must be delivered to the antenna. Second, simultaneously sufficient free electrons should be generated through the help of the ignition appendix 10. In a practical embodiment, an ignition voltage was found to be above 3 kV, although it varies with the gas filling in the discharge vessel 4. To keep the RF driver circuit simple, the ignition frequency is chosen the same as the lamp operating frequency. The starting circuit 150 is switched off after a successful ignition in order to avoid degrading the discharge vessel 4, to eliminate any influence on the main resonant load network, and to remove any loss in the starting circuit.

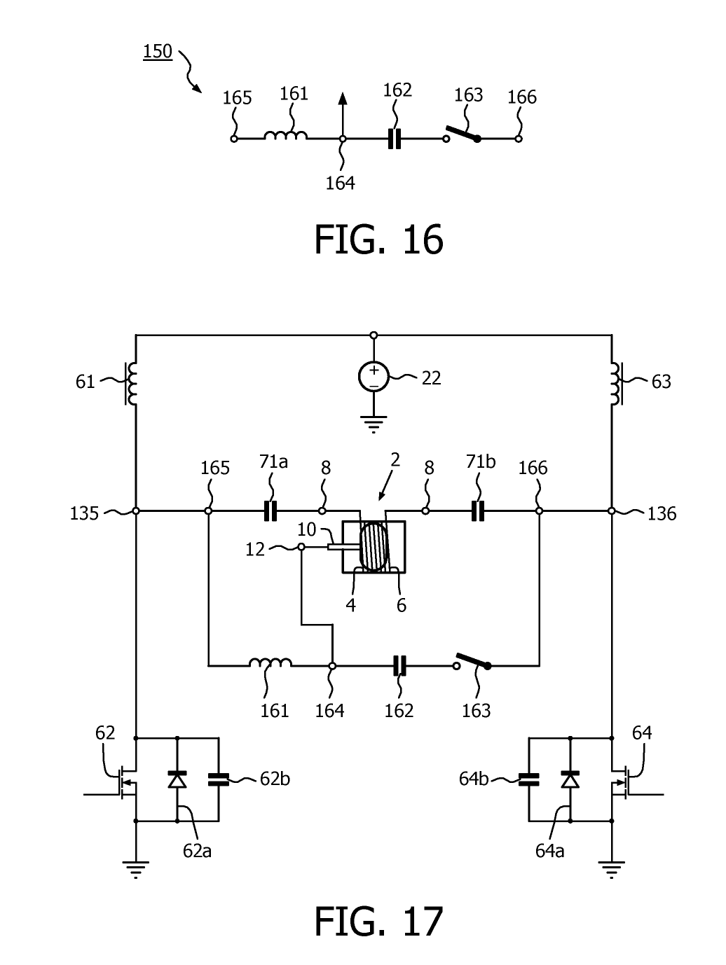

Referring to FIG. 16, the starting circuit (or ignition circuit) 150 comprises a starting inductor 161 connected in series to a starting capacitor 162 and a separating switch 163. The series connection of the starting inductor 161, the starting capacitor 162 and the separating switch 163 has terminals 165 and 166. A node 164 interconnecting the starting inductor 161 and the starting capacitor 162 is connected to the ignition appendix 10 through ignition terminal 12. The component values of the starting inductor 161 and the starting capacitor 162 are selected such that the starting circuit is tuned to a resonant frequency very close to the operating frequency of the ED lamp 2, e.g. 13.56 MHz. With a high quality factor, the voltage supplied to the ignition appendix 10 can be sufficiently high, so that the gas in the ignition appendix 10 breaks down and subsequently the main discharge in the discharge vessel 4 is ignited.

The starting inductor 161 can be an air coil inductor or and inductor with a magnetic core. Shielding of the starting inductor 161 by a metallic enclosure can be applied to avoid detuning the starting circuit due to stray capacitances. It is important that the quality factor of the inductor is stays high.

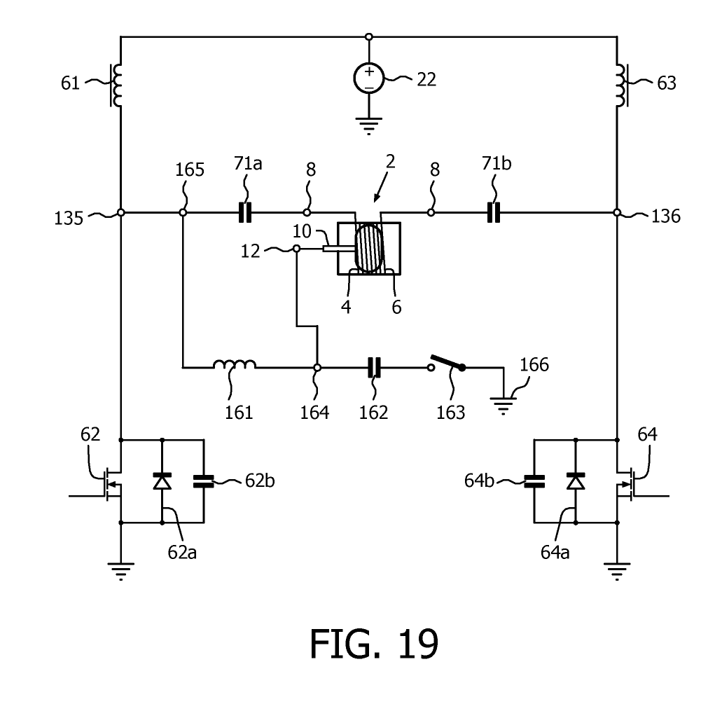

The separating switch 163 can be a mechanical switch such as a relay switch, or can be a semiconductor switch, which is preferred for its controllability. To facilitate the switching of separating switch 163, one terminal of separating switch 163 may be connected to the ground (shown in more detail below with reference to FIG. 19 and following Figures).

Furthermore, it is also possible to use bimetallic switches. By placing a bimetallic switch close to the ED lamp 70, advantage can be taken of the heat generated by the lamp to control the switching of the bimetallic switch on and off automatically through the heat produced by the lamp.

Referring to FIG. 17, in an embodiment the terminals 165 and 166 of the starting circuit 150 are connected to the drain electrodes of the MOSFET switches 62 and 64 (nodes 135 and 136, respectively). Here, the starting circuit 150 is a parallel circuit to the main resonant load network and, if properly designed, may have a limited influence on the main resonant load network.

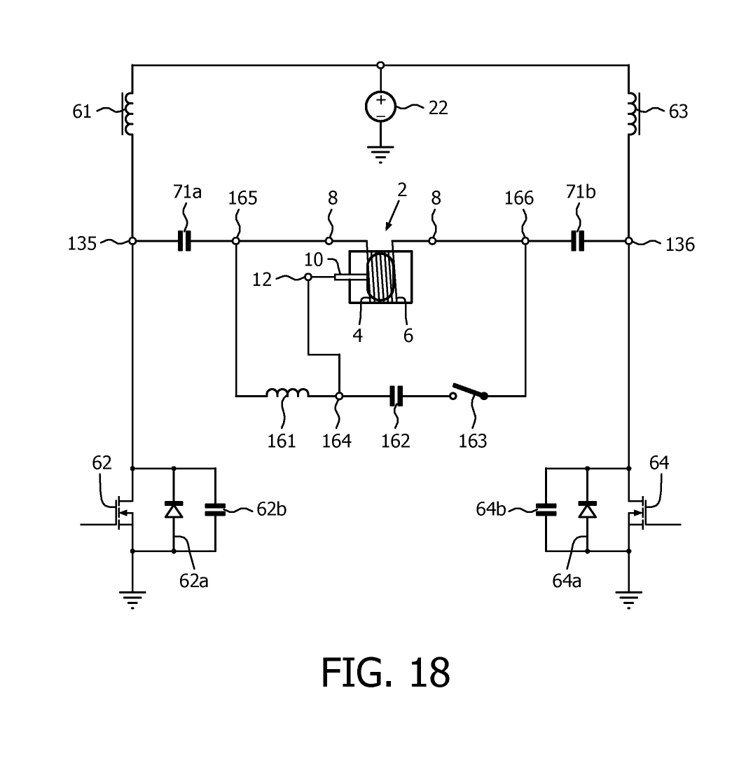

In an alternative embodiment shown in FIG. 18, the terminals 165 and 166 of the starting circuit 150 are connected to the antenna terminals 8 of the antenna 6 of the ED lamp 2. In this embodiment, the influence of the starting circuit on the main resonant network is larger than in the embodiment of FIG. 17.

As shown in the embodiment of FIG. 19, one terminal of the separating switch 163 may be connected to ground to facilitate the switching of the separating switch 163. Thus, the terminal 165 of the starting circuit 150 is connected to one of the drain electrodes (node 135 as shown, or alternatively node 136) of the lamp driver circuit, and the other terminal 166 of the starting circuit 150 is connected to ground. In such an embodiment, the voltage applied to the starting circuit 150 is reduced to a half when compared to the embodiment of FIG. 17. Therefore, in the starting circuit 150 of FIG. 19 the quality factor needs to be increased to ensure a sufficient ignition voltage, e.g. by increasing the inductance of the starting inductor 161, and decreasing the capacitance of the starting capacitor 162.

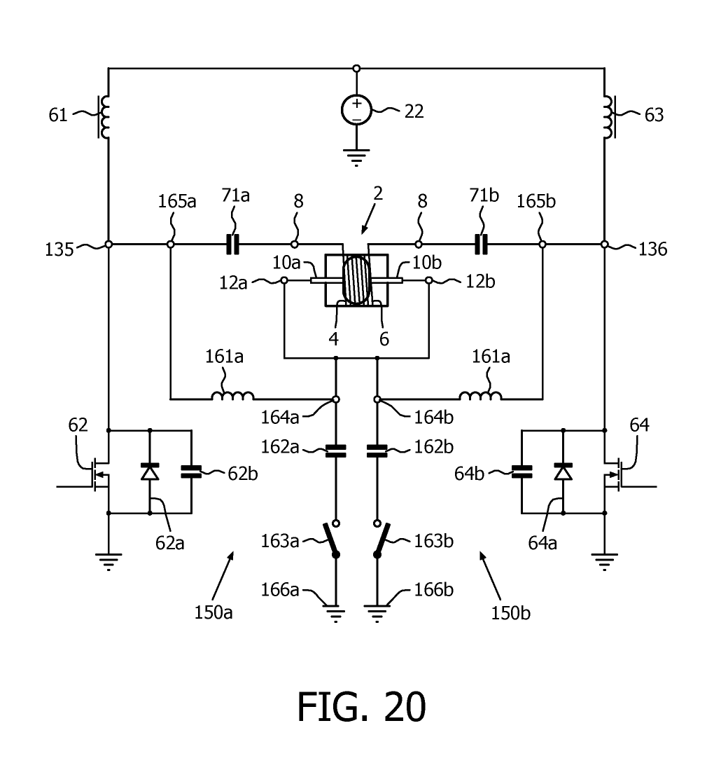

Referring to FIG. 20, in a further embodiment a symmetrical starting circuit may be used, in particular when the ED lamp 2 comprises two ignition appendices 10a, 10b, the ignition appendix 10a having an ignition terminal 12a, and the ignition appendix 10b having an ignition terminal 12b. A first starting circuit section 150a comprises, between terminals 165a and 166a, a series arrangement of a starting inductor 161a, a starting capacitor 162a and a separating switch 163a. A second starting circuit section 150b comprises, between terminals 165b and 166b, a series arrangement of a starting inductor 161b, a starting capacitor 162b and a separating switch 163b. The terminal 165a of the first starting circuit section 150a is connected to the node 135 and the series resonant capacitor 71a. Similarly, the terminal 165b of the second starting circuit section 150b is connected to the node 136 and the series resonant capacitor 71b. A node 164a between the starting inductor 161a and the starting capacitor 162a is connected to the terminal 12a of the ignition appendix 10a. A node 164b between the starting inductor 161b and the starting capacitor 162b is connected to the terminal 12b of the ignition appendix 10b. Both the terminal 166a and the terminal 166b are connected to ground.

In the circuit of FIG. 20, the ignition voltage may be doubled when compared to the ignition voltage generated in the circuit of FIG. 19. Both separating switches 163a and 163b are referred to ground, and therefore easy to drive.

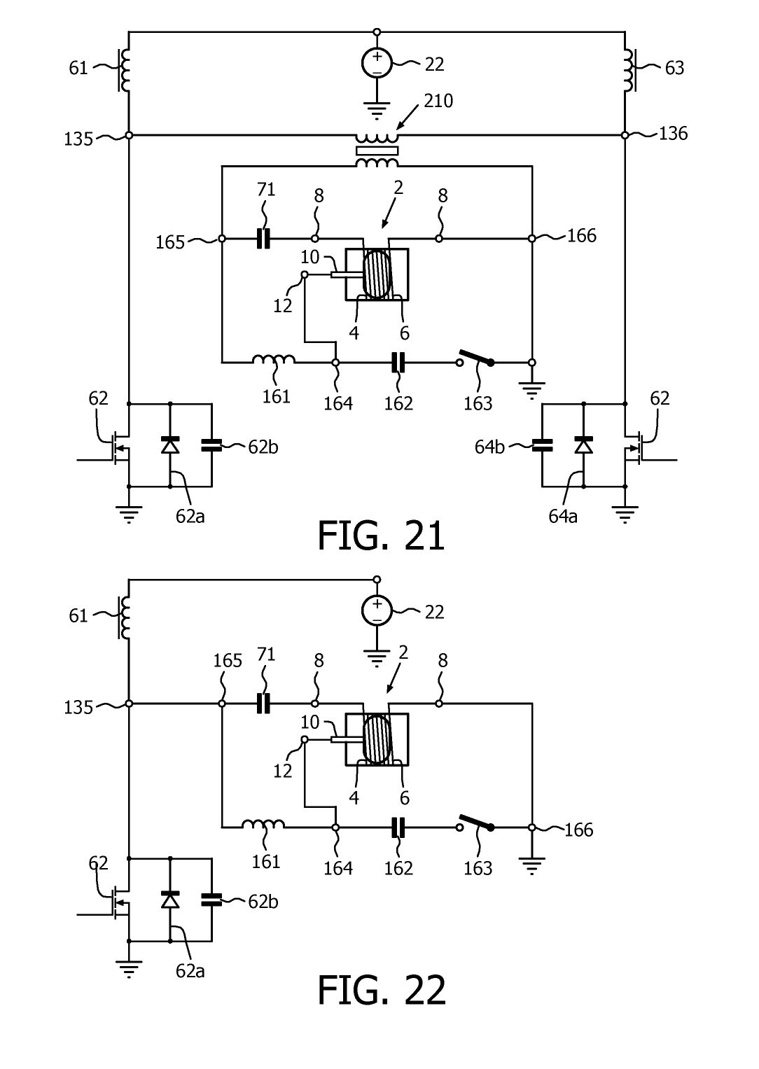

Referring to FIG. 21, in the class E converter, a transformer 210 has a primary winding connected between nodes 135 and 136, and a secondary winding connects, between nodes 165 and 166, a parallel arrangement of a first series arrangement of the series resonant capacitor 71 and the antenna 6 of the ED lamp 2, and a second series arrangement of the starting inductor 161, the starting capacitor 162, and the separating switch 163. The node 164 between the starting inductor 161 and the starting capacitor 162 is connected to the terminal 12 of the ignition appendix 10 of the ED lamp 2. The node 162, and thereby one side of the separating switch 163, is connected to ground, which is not possible in the related circuit of FIG. 17. Connecting the node 162 to ground facilitates cabling and making measurements in the circuit.

In the circuit of FIG. 21, the transformer 210 may be used for impedance matching, which is useful since the lamp resistance, which is a plasma resistance resulting from the discharge in the lamp, typically is very low.

FIG. 22 illustrates a circuit when the class E converter is single-ended. The single-ended converter comprises a first inductor 61 (DC choke) and a MOSFET 62 coupled in series between a PFC circuit 22 and ground. A node 135 between the first inductor 61 and the MOSFET 62 is connected to a parallel arrangement, between terminal 165 connected to node 135, and terminal 166 connected to ground, of a first series arrangement of a series resonant capacitor 71 and an antenna 6 of the ED lamp 2, and a second series arrangement of a starting inductor 161, a starting capacitor 162, and a separating switch 163. As in FIGS. 19, 20 and 21, one side of the separating switch 163 is connected to ground.

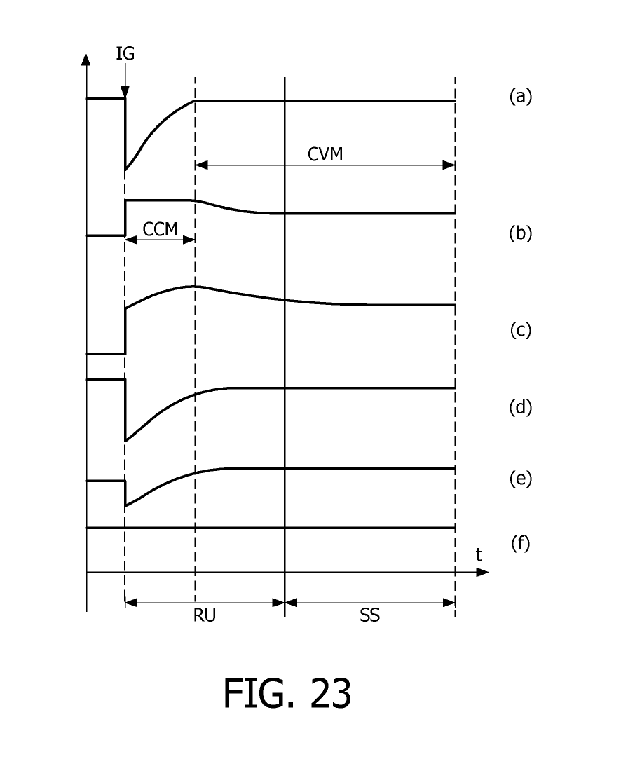

The impedance of the ED lamp 2, which may be e.g. an inductive HID lamp, varies during ignition, and a subsequent run-up phase preceding a steady-state phase. Since the impedance matching network is designed for steady-state operation of the ED lamp 2, the class E converter is not operated in an optimum mode during the run-up phase. To prevent the converter from excessive loss during the run-up phase, the DC power source (represented by PFC circuit 22) is operated as a current source after ignition of the discharge in the discharge vessel 4, thereby limiting the power delivered to the class E converter. FIG. 23 qualitatively illustrates the behavior of the ED lamp during the run-up phase when operating the DC power source as a current source.

In FIG. 23, curves (a)-(f) represent the following quantities in time t:

DC voltage delivered by the DC power source;

DC current delivered by the DC power source;

Input power to the class E converter;

ED lamp current;

Class E converter efficiency; and

Class E converter frequency.

FIG. 23 further indicates a point in time IG where ignition takes place, a time period CCM in which the DC power source operates in constant current mode, a time period CVM in which the DC power source operates in constant voltage mode, a time period RU representing the run-up phase, and a time period SS representing the steady-state phase.

As can be seen in FIG. 23, immediately after the time IG, the DC power source voltage reaches its minimum (curve (a)) and the DC power source current reaches its maximum (curve (b)), because the DC power source has a maximum output current limiting function. Here, the DC power source is operated as a current source in this time period RU, limiting the power delivered to the class E converter.

During the time period RU, after time IG, the power source voltage ramps up to reach a maximum value. After this point in time, the power source operation mode is changed from CCM to CVM. During the time period RU, the lamp current ramps up (curve (d)), and so does the converter efficiency (curve (e)). During the time period RU, no tuning of the impedance matching circuit is involved, i.e. the ED lamp is driven under a fixed impedance matching. During the time periods RU and SS, the converter frequency does not change, i.e. the ED lamp is driven at a fixed frequency. Normally, after a lapse of time, e.g., some minutes, the ED lamp reaches a steady-state (time period SS).

To implement the operation of the class E converter as described above, the PFC circuit 22 (i.e. the DC power source) needs to have a maximum output current limiting function. When the output current of the DC power source reaches the maximum value (which value can be selected by the designer of the DC power source), the output DC voltage is reduced (see t=IG) until the output current can be stabilized at the chosen maximum value. As the load varies, the DC voltage changes in order to keep the DC current constant at its maximum until the DC voltage reaches its normal value (see CCM). Then the PFC circuit 22 operates in constant voltage mode (see CVM).

In the embodiments discussed above, each resonant load circuit comprising inductor 61 and series resonant capacitor 71a, or inductor 63 and series resonant capacitor 71b, is tuned to the same resonant frequency as the starting circuit 150 comprising starting inductor 161 and starting capacitor 162. When the discharge in discharge vessel 4 of the ED lamp 2 has been started by the starting circuit 150 (with the separating switch 163 in closed position), the separating switch 163 is opened in the run-up and steady-state time periods RU and SS, respectively.

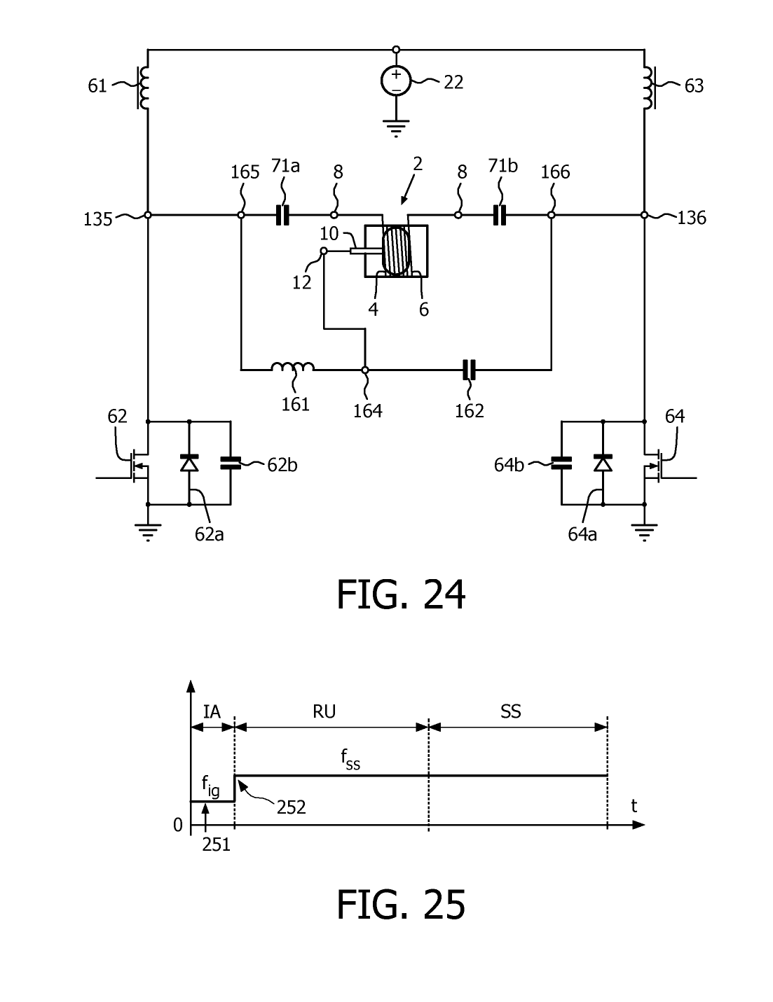

In an alternative embodiment, the separating switch is replaced by an electrical connection, and the resonant load circuit comprising series resonant capacitors 71a and 71b and the ED lamp 2, is tuned to a first resonant frequency which is substantially different from a second resonant frequency of the starting circuit 150 comprising starting inductor 161 and starting capacitor 162. An embodiment of the class E converter having such characteristics is shown in FIG. 24.

FIG. 24 shows a similar arrangement as the circuit shown in FIG. 17, where a first difference can be readily recognized in that the separating switch 163 shown in FIG. 17 has been replaced with a permanent through connection between the starting capacitor 162 and the terminal 166 in FIG. 24. A second difference lies in the substantially different resonant frequencies to which the resonant load circuit and the resonant starting circuit are tuned. As an example, the first resonant frequency of the resonant load circuit may be about twice as high as the second resonant frequency of the resonant starting circuit. Thus, again for example, the first resonant frequency may be slightly less than 13.56 MHz, and the second resonant frequency may be slightly less than 6.78 MHz for a normal operating frequency of fₛₛ=13.56 MHz and an ignition frequency of f_{g}=6.78 MHz, such that the class E converter is operated in an inductive region, slightly off-resonance.

In operation, when starting (igniting) the ED lamp, the class E converter is driven at about the ignition frequency f_{ig} of, e.g., 6.78 MHz, and when the ED lamp has been ignited, the class E converter is driven at the normal operating frequency fₛₛof, e.g., 13.56 MHz. Once the ED lamp operates in steady-state, the starting circuit has relatively little effect on the resonant load circuit because of the very high impedance of the resonant starting circuit at the normal operating frequency fₛₛ.

FIG. 25 illustrates, for a circuit like the one shown in FIG. 24, the operating frequency of the class E converter in time t, in different operating phases. In a time period IA, the ignition appendix 10 is ignited by powering the class E converter at the ignition frequency f_{ig} (as indicated by arrow 251). In a subsequent time period RU of run-up of the ED lamp, the operating frequency of the class E converter is changed from the ignition frequency f_{ig} to the normal operating frequency fₛₛ. Immediately at the start of time period RU (as indicated with arrow 252), the gas in the discharge vessel 4 is ignited, and the discharge in the ignition appendix 10 extinguishes automatically due to the shift of the operating frequency. The run-up current control method described above with reference to FIG. 23 is applicable also to the circuit of FIG. 24, and the operation illustrated with reference to FIG. 25: the PFC circuit 22 operates as a current source in the run-up phase after the ignition of the gas in the discharge vessel 4, and as a voltage source in the steady-state phase SS (and part of the run-up phase).

Next, the control of the switching of the MOSFETs, as symbolized in FIGS. 13 and 15 by blocks 65, 66, and blocks 130-134, is described in detail. Silicon based power switches such as power MOSFETs have a large intrinsic parasitic capacitance (see for example capacitors 62b, 64b in FIGS. 6, 11-13, 15, 17-22 and 24). Depending on the chip die area, an equivalent gate input capacitance, which may be represented by a gate input capacitor Cᵢₛₛ, can be several nF. The power P_{Gate} needed to drive a MOSFET with a conventional gate driver can be calculated from the following equation:

P_{Gate}=Q_{G}·V_{G}·fₛ

where Q_{G} is the total gate charge, V_{G} is the gate drive voltage and fₛ is the switching frequency. Gate drive loss was considered to be small in comparison to other losses in power converters operating at switching frequencies below 500 kHz. However, when switching at very high frequencies (>1 MHz), the gate drive loss cannot be neglected anymore, and often becomes a significant part of the total loss. At a switching frequency beyond 10 MHz, the gate drive power P_{Gate} can easily exceed 10 W.

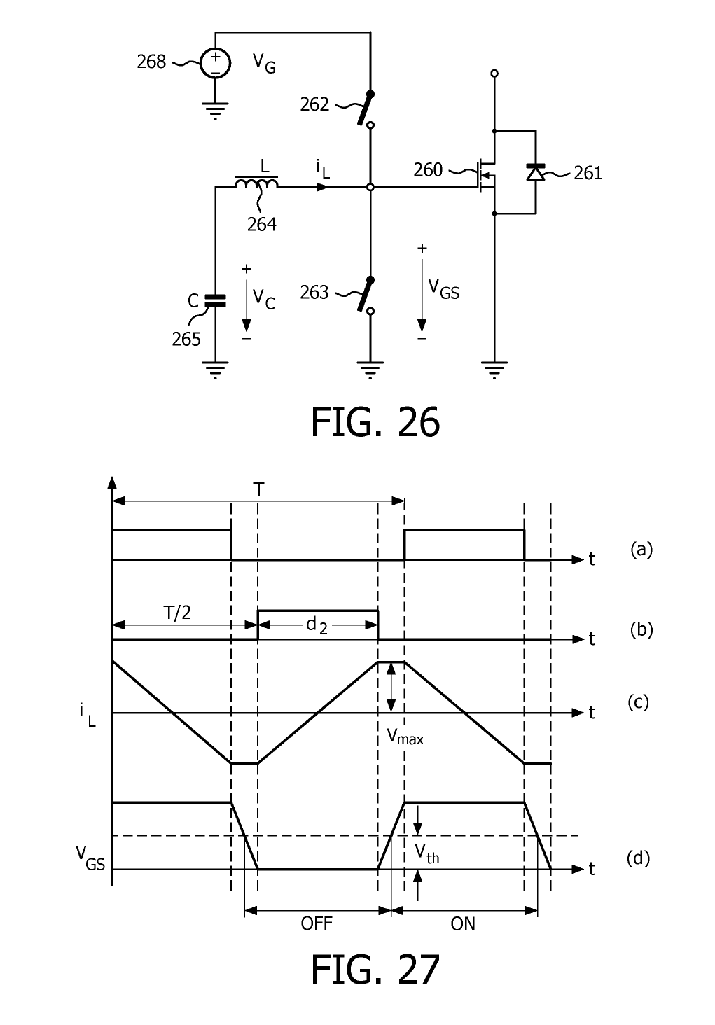

In relation to using high frequency gate drivers, various gate drive circuits have been studied. FIG. 26 shows a popular existing topology, which is referred to as a Constant Current Resonant Transition, CCRT, gate drive circuit, driving a MOSFET 260 having an intrinsic and/or extrinsic diode 261. The CCRT gate drive circuit comprises a half bridge switching circuit with first switch 262 and second switch 263, an inductor L 264, and a (DC blocking) capacitor C 265. In practice, the first switch 262 and the second switch 263 may be implemented as MOSFETs. A DC gate supply 268 supplying a voltage V_{G} is connected through first switch 262 to a parallel arrangement of the (gate of the) MOSFET 260, the second switch 263, and a series arrangement of the inductor L 264 and the capacitor C 265. Idealized operating waveforms of the CCRT gate drive circuit of FIG. 26 are shown in FIG. 27.

FIG. 27 depicts four curves of different quantities in time t. Curve (a) illustrates a control voltage to close (voltage high) and open (voltage low) the first switch 262. Curve (b) illustrates a control voltage to close (voltage high) and open (voltage low) the second switch 263. The curves (a) and (b) illustrate that the switches are controlled with a 180 degrees phase difference. Within a cycle time period T, a duty cycle of the first switch 262 is indicated by time period d₁, and a duty cycle of the second switch is indicated by time period d₂. When the CCRT gate drive circuit of FIG. 26 is operated in this way, a current i_{L} through the inductor L 264 is generated as shown in curve (c). The current i_{L} has a quasi-triangular shape with a maximum value Iₘₐₓ. Curve (d) shows a gate-source voltage v_{GS} and a threshold voltage Vₜₕ of the MOSFET 260. When the gate-source voltage v_{GS} is lower than the threshold voltage Vₜₕ, the MOSFET 260 is switched OFF (non-conducting), whereas the MOSFET is switched ON (conducting) when the gate-source voltage v_{GS} is higher than the threshold voltage Vₜₕ.

The advantages of the existing resonant gate drive circuit as illustrated with reference to FIGS. 26 and 27 include a simple circuit topology, zero-voltage switching, gate energy recovery, and variable frequency and duty cycle operation. However, this gate drive circuit has a high conduction loss because of the inductor current i_{L} always circulating in the circuit. When operating at a very high frequency, the value of the inductor L 264 has to be very small in order to be able to store sufficient energy to charge the gate input capacitor Cᵢₛₛ (not shown) during the short transition period when the first switch 262 and the second switch 263 both are switched off (see curves (a) and (b)). The quality factor of the gate resonant tank comprising inductor L 264 and capacitor C 265 decreases as the inductance of the inductor L 264 decreases, and the amplitude Iₘₐₓ of the inductor current i_{L} will be unacceptably large. This leads to a very high conduction loss, which can even be higher than that in a conventional gate drive circuit. In fact, at above 10 MHz switching frequency, this gate drive operation scheme is not suitable for driving a power MOSFET 260 having a relative high gate input capacitance, i.e. a gate input capacitance of, e.g., about 2 nF or more.

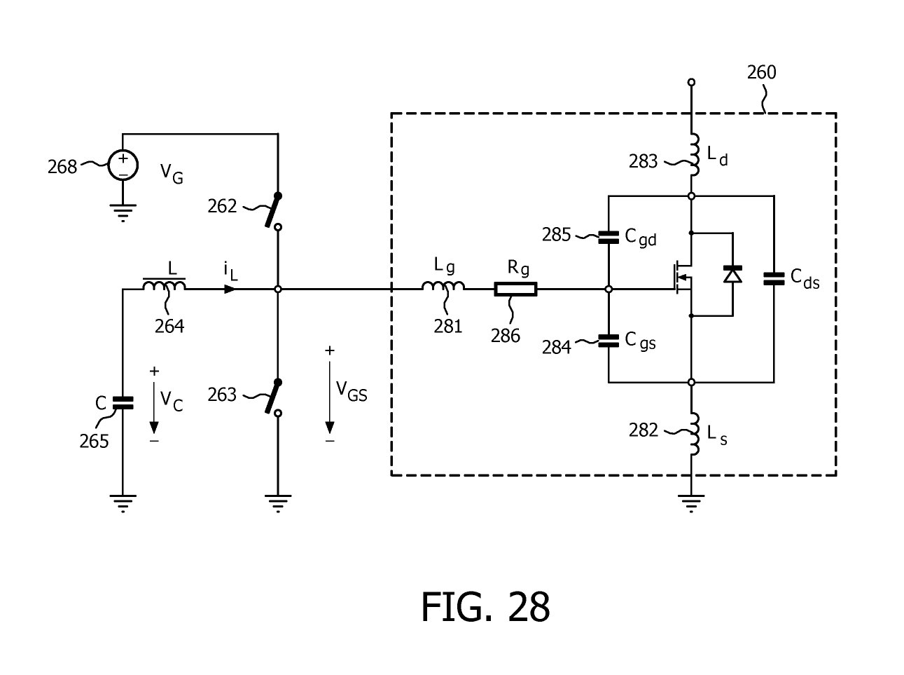

According to the present invention, a gate drive operation scheme is proposed to solve the above problem. Although the circuit topology, as shown in FIG. 28, is similar to the one shown in FIG. 26, the principle of operation is totally different.

In FIG. 28, all the parasitic components of the MOSFET 260 are shown as lumped network components. A gate inductance is represented by a gate inductor L_{g} 281. A source inductance is represented by a source inductor Lₛ 282. A drain inductance is represented by a drain inductor L_{d} 283. A gate-source capacitance is represented as a gate-source capacitor C_{gs} 284. A gate-drain capacitance is represented as a gate-drain capacitor C_{gd} 285. The gate input capacitor Cᵢₛₛ referred to above has a capacitance which is the sum of the capacitance of the gate-source capacitor C_{gs} 284 and the capacitance of the gate-drain capacitor C_{gd} 285. A gate resistance is represented as a gate resistor R_{g} 286. In the gate drive circuit of FIG. 28, the inductor L 264, the gate inductor L_{g} 281, the source inductor Lₛ 282, the capacitor C 265 and the gate input capacitor Cᵢₛₛ may form a resonant circuit having a resonance frequency fₒ which is equal to, or very close to, the switching frequency of the gate drive circuit, e.g. 13.56 MHz. Since the capacitor C 265 is quite large in order to maintain a stable DC voltage V_{c} across it, it has a very low impedance at the switching frequency. Consequently, the resonance frequency fₒ is mainly determined by the values of the inductor L 264, the gate inductor L_{g} 281, the source inductor Lₛ 282, and the gate input capacitor Cᵢₛₛ, according to the following equation:

fₒ=1/(2·π·SQRT((L+L_{g}+Lₛ)·Cᵢₛₛ))

where SQRT denotes a square root function.

For a known switching frequency fₛ and known values of the parasitic components of the MOSFET 260, the value of the inductor L 264 can be calculated by setting fₒ=fₛ. Note that in practice an inductance of a printed circuit board, PCB, track should also be taken into account as part of the resonant inductor L 264.

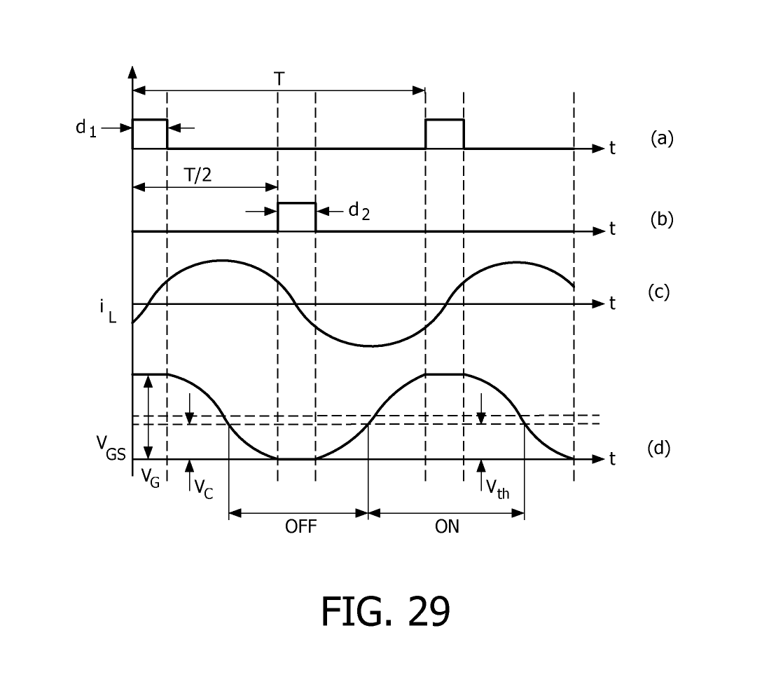

FIG. 29 illustrates the control signals and key operating waveforms designed as described with reference to FIG. 28. Like in FIG. 27, curve (a) illustrates a control voltage to close (voltage high) and open (voltage low) the first switch 262. Curve (b) illustrates a control voltage to close (voltage high) and open (voltage low) the second switch 263. The curves (a) and (b) illustrate that the switches are controlled with a 180 degrees phase difference. Within a cycle time period T, a duty cycle of the first switch 262 is indicated by time period d₁, and a duty cycle of the second switch is indicated by time period d₂. When the gate drive circuit of FIG. 28 is operated, a current i_{L} through the inductor L 264 is generated as shown in curve (c). Curve (d) shows a gate-source voltage v_{GS} and a threshold voltage Vₜₕ of the MOSFET 260. When the gate-source voltage v_{GS} is lower than the threshold voltage Vₜₕ, the MOSFET 260 is switched OFF (non-conducting), whereas the MOSFET is switched ON (conducting) when the gate-source voltage v_{Gs} is higher than the threshold voltage Vₜₕ.

According to FIG. 29, the duty cycles d₁ and d₂ are very small, typically between 0.1 and 0.3. In fact, in the gate drive circuit as operated according to FIG. 29, the first switch 262 and the second switch 263 periodically clamp the gate voltage v_{Gs} to the gate supply voltage V_{G} and ground for a very short time to provide energy to the gate resonant tank in order to sustain the resonance. Here, the RMS currents running through the first and second switches 262, 263 are significantly lower than in the CCRT gate drive circuit as illustrated with reference to FIGS. 26 and 27. The operation control scheme also allows for a higher combined gate inductance (the inductances of inductor L 264, gate inductor L_{g} 281, and source inductor Lₛ 282) to be used, and thus a higher quality factor of the gate resonant tank, and a lower current in the gate resonant tank compared to the CCRT gate drive circuit of FIGS. 26 and 27. According to FIGS. 28 and 29, the lead inductances (the inductances of the gate inductor L_{g} 281 and source inductor Lₛ 282) of the MOSFET 260 are utilized as part of the resonance inductor. In the CCRT gate drive circuit as illustrated with reference to FIGS. 26 and 27, the lead inductances would be problematic at very high frequencies.

In most cases, the first switch 262 and the second switch 263 are switched with the same duty cycle, and their control signals have a phase difference of 180 degrees. In such a way, the voltage V_{C} across the capacitor C 265 is equal to half the gate supply voltage V_{G}.

In an ideal situation, as can be seen from FIG. 29, the inductor current i_{L} and the gate-source voltage v_{Gs} are close to a sinusoidal shape. The quality factor of the gate resonant circuit determines the current and voltage wave shapes.

In the gate drive circuit as illustrated with reference to FIGS. 28 and 29, the amount of energy that can be recovered is directly related to the intrinsic gate resistance as represented by R_{g} 286 (see FIG. 28). A very low R_{g} allows for the majority of the energy charging the gate capacitor Cᵢₛₛto be recovered. RF MOSFETs usually have a metal gate, where a gate resistance of less than 0.5 Ohm is possible, and can therefore reduce the gate drive power significantly.

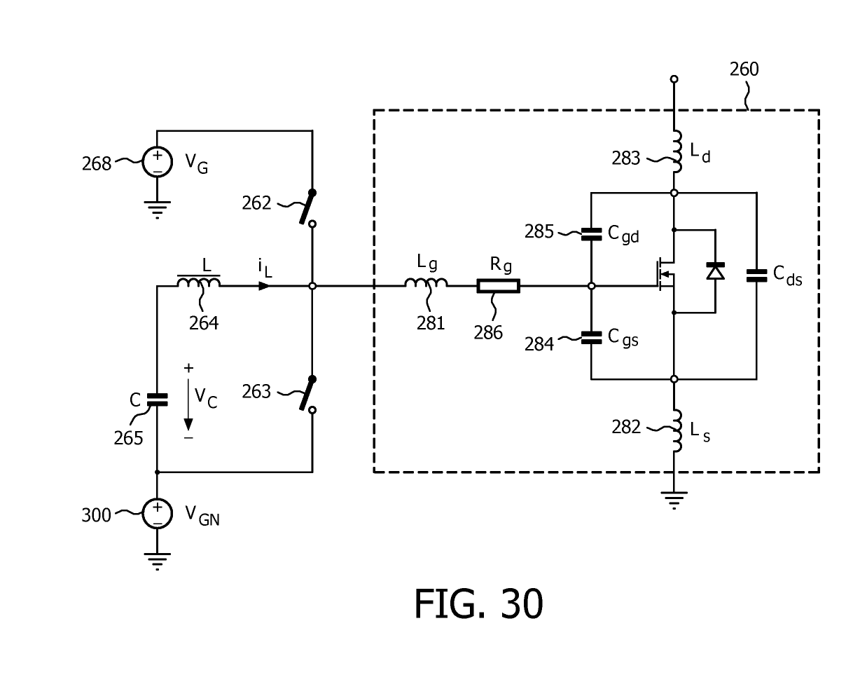

In an alternative embodiment of the gate drive circuit shown in FIG. 30, a second gate supply 300 supplying a voltage V_{GN} is added to the gate drive circuit in order to control the duty cycle of the MOSFET 260. The gate supply 300 may supply a constant voltage, or a variable, controllable voltage. In FIG. 30, the second switch 263 is connected across the series arrangement of the inductor L 264 and the capacitor C 265, where the terminal of the capacitor C 265 facing away from the inductor L 264 is connected to the second gate supply 300. In this case, V_{C}=(V_{G}+V_{GN})/2−V_{GN}. As a result, a DC bias is added to the gate-source voltage v_{GS}.

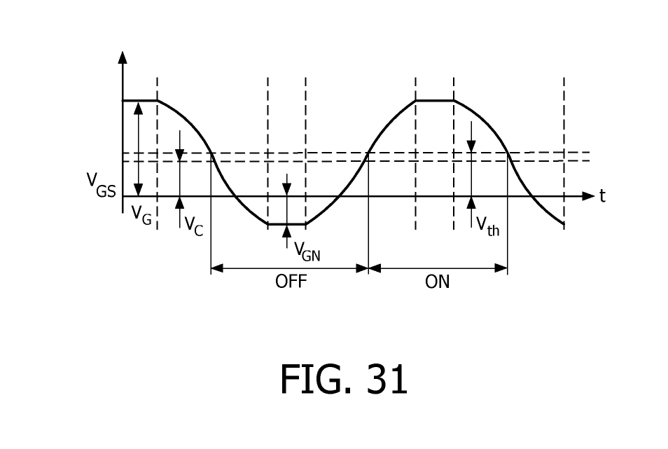

FIG. 31 shows a curve representing the gate-source voltage v_{GS} in the gate drive circuit of FIG. 30. It can be seen that with control of the voltage V_{GN}, the effective operating duty cycle of the MOSFET 260 can be controlled.

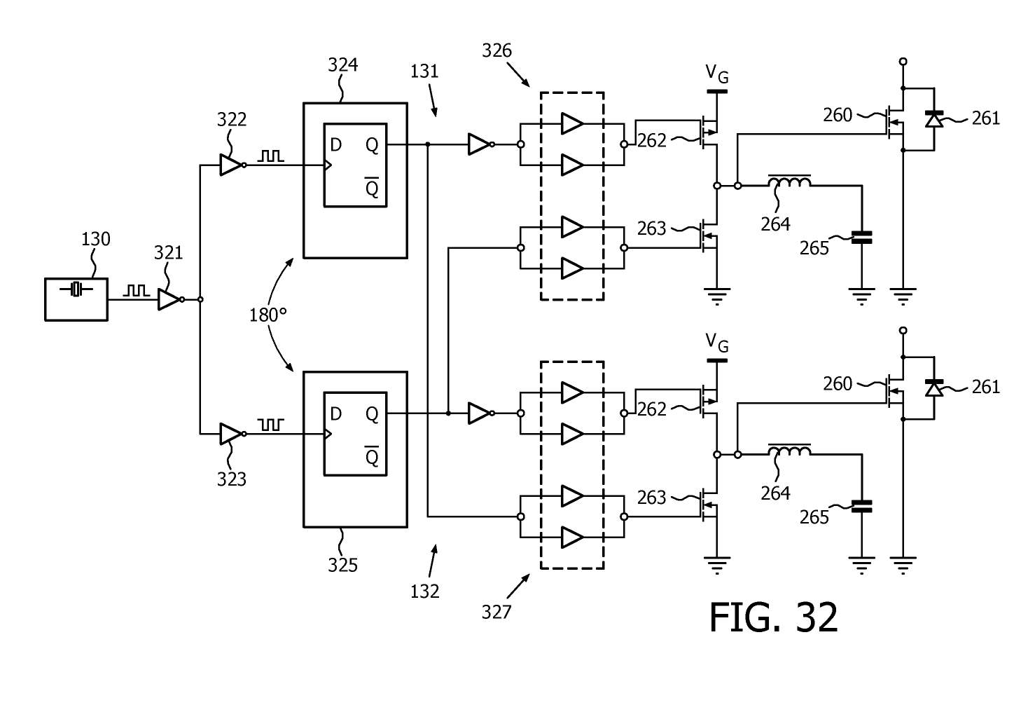

FIG. 32 illustrates, by way of example only, a logic circuit coupled between a crystal or clock generator 130 and two gate drive circuits as shown in FIG. 28, the first and the second switch 262, 263 implemented as MOSFET switches. The clock generator 130 supplies a clock signal to an input of an inverting gate 321, the output of which is supplied to the inputs of respective inverting and non-inverting gates 322, 323. Each of the outputs of the gates 322, 323 are connected to D-flip-flop duty cycle controllers 324, 325 which in turn control gate drive circuits 326, 327, respectively, of the MOSFETS embodying the first switch 262 and the second switch 263, respectively. In FIG. 32, each MOSFETS 260 is controlled by a gate drive circuit as shown in FIG. 28.

As has been explained above, a power driver circuit for an electrodeless discharge lamp comprises a push-pull class E converter comprising power supply terminals for receiving a DC supply voltage, and lamp output terminals for supplying power to an antenna of the lamp. The converter has a first switching leg and a second switching leg arranged in parallel between the power supply terminals. The first switching leg has a series arrangement of a first switching element and a first driver circuit inductor having a common first node. The second switching leg has a series arrangement of a second switching element and a second driver circuit inductor having a common second node. The lamp output terminals are coupled between the first node and the second node. A lamp impedance matching network is coupled between the first node and the second node, wherein the impedance matching network comprises at least one series resonant capacitor coupled in series with the lamp output terminals. A starting circuit comprises a series arrangement of a starting inductor and a starting capacitor coupled between a first starting circuit terminal and a second starting circuit terminal. The first starting circuit terminal is coupled between the first switching element of the power driver circuit and a first lamp output terminal. A node coupling the starting inductor and the starting capacitor is configured to be coupled to an ignition appendix of the lamp. A gate drive circuit is configured to supply a near-sinusoidal gate drive current.

With the invention, the following advantages may be gained:

The RF power driver circuit may have a symmetrical circuit layout, which reduces an emitted electromagnetic field. The output voltage contains only odd harmonics (1st, 3rd, 5th, . . . ) and the output (lamp) current is nearly sinusoidal.

The lamp impedance matching network of the power driver circuit may have the least amount of passive components. Only capacitors are needed for impedance matching. No inductive components need be present in the matching network. The overall size of the PCB comprising the power driver circuit can therefore be reduced.

The intrinsic output capacitance Cₒₛₛ of the transistor may be fully utilized as an integral part of the load network. The differential capacitor C_{d} in the matching network may be absorbed by Cₒₛₛ. This further reduces the components in the power driver circuit to a minimum.

A selection guideline for the transistor (MOSFET) is that its output capacitance Cₒₛₛ matches the required class E parallel capacitance Cₚ plus the differential capacitance C_{d} in the matching network. In such a way, the device with the lowest possible ON-resistance R_{DSON} is used. Therefore, the conduction (RMS) loss of the class E converter is minimized.

The output of the class E converter is not matched to the standard 50 Ohm RF load. Instead, the RF driver drives the lamp directly. No external matching box is present. This eliminates the associated loss in the matching box and minimizes the total parts count.

The connecting cable between the driver and the lamp is part of the power driver circuit load and may be characterized in order to design the impedance matching network.

The power driver circuit is based on a multistage drive scheme. Resonant gate drivers are used to reduce the gate drive loss.

The power delivered to the lamp is controlled via the regulation of the DC bus voltage, i.e., the DC input voltage of the class E stage. This DC voltage is produced by a PFC stage.

The driver may be operated at a fixed frequency in one of the ISM bands (e.g., 13.56 MHz).

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly, and not necessarily mechanically.

A single processor or other unit may fulfill the functions of several items recited in the claims.

1. A power driver circuit for an electrodeless discharge lamp, the power driver circuit comprising a push-pull class E converter comprising:
power supply terminals for receiving a DC supply voltage;
lamp output terminals for supplying power to an antenna of the lamp;
a first switching leg and a second switching leg arranged in parallel between the power supply terminals;
the first switching leg comprising a series arrangement of a first switching element and a first driver circuit inductor having a common first node;
the second switching leg comprising a series arrangement of a second switching element and a second driver circuit inductor having a common second node;
the lamp output terminals being coupled between the first node and the second node; and
a lamp impedance matching network coupled between the first node and the second node, wherein the impedance matching network comprises at least one series resonant capacitor coupled in series with the lamp output terminals.

2. The power driver circuit of claim 1, wherein the lamp impedance matching network comprises a series arrangement of a first series resonant capacitor, the lamp output terminals, and a second series resonant capacitor.

3. The power driver circuit of claim 1, wherein the lamp impedance matching network further comprises a differential capacitor coupled between the first node and the second node.

4. The power driver circuit of claim 1, wherein the lamp impedance matching network further comprises a first shunt capacitor coupled in parallel to the first switching element, and a second shunt capacitor coupled in parallel to the second switching element.

5. The power driver circuit of claim 1, wherein the lamp impedance matching network further comprises a differential capacitance C_{d} coupled between the first node and the second node, a first capacitance Cₚ coupled in parallel to the first switching element, and a second capacitance Cₚ coupled in parallel to the second switching element,
wherein the first and the second switching elements are MOSFETs each having an intrinsic output capacitor having an equivalent capacitance Cₒₛₛ, and wherein the MOSFET is designed such that Cₒₛₛ=Cₚ+C_{d}.

6. The power driver circuit of claim 1, wherein the lamp impedance matching network further comprises a differential capacitor having a capacitance C_{d} and being coupled between the first node and the second node, a first capacitance Cₚ coupled in parallel to the first switching element, and a second capacitance Cₚ coupled in parallel to the second switching element,
wherein the first and the second switching elements are MOSFETs each having an intrinsic output capacitance Cₒₛₛ,
wherein the MOSFET is designed such that Cₒₛₛ≧Cₚ, and
wherein the differential capacitor is designed such that C_{d}=Cₒₛₛ−Cₚ.

7. The power driver circuit of claim 1, wherein a primary winding of a transformer has a first primary winding terminal coupled between the first driver circuit inductor and the first switching element of the power driver circuit, wherein the primary winding of the transformer has a second primary winding terminal coupled between the second driver circuit inductor and the second switching element of the power driver circuit, and wherein the lamp impedance matching network is coupled between a first and a second secondary winding terminal of a secondary winding of the transformer.

8. The power driver circuit of claim 1, wherein the driver circuit is configured to operate at a frequency in an Industrial-Scientific-Medical, ISM, band, in particular at a frequency of 13.56 MHz.

9. The power driver circuit of claim 1, further comprising a starting circuit comprising:
a series arrangement of a starting inductor and a starting capacitor coupled between a first starting circuit terminal and a second starting circuit terminal;
wherein the first starting circuit terminal is coupled between the first switching element of the power driver circuit and a first lamp output terminal, and
wherein the lamp has an ignition appendix, and a node coupling the starting inductor and the starting capacitor is configured to be coupled to the ignition appendix of the lamp.

10. The power driver circuit of claim 9, wherein, the first starting circuit terminal is coupled between the first driver circuit inductor and the first switching element of the power driver circuit.

11. The power driver circuit of claim 9, wherein the second starting circuit terminal is coupled between the second switching element of the driver circuit and a second lamp output terminal of the lamp.

12. The power driver circuit of claim 11, wherein the second starting circuit terminal is coupled between the second drive circuit inductor and the second switching element of the power driver circuit.

13. The power driver circuit of claim 9, wherein the second terminal of the series arrangement is coupled to ground.

14. The power driver circuit of claim 9, wherein a primary winding of a transformer has a first primary winding terminal coupled between the first driver circuit inductor and the first switching element of the power driver circuit, wherein the primary winding of the transformer has a second primary winding terminal coupled between the second driver circuit inductor and the second switching element of the power driver circuit, and wherein the starting circuit is coupled between a first and a second secondary winding terminal of a secondary winding of the transformer.

15. The power driver circuit of claim 9, wherein the series arrangement further comprises a separating switch coupled in series to the starting inductor and the starting capacitor, wherein the separating switch is selected from a group of separating switches comprising a relay, a MOSFET and a bimetallic switch.

16. The power driver circuit of claim 9, wherein the lamp impedance matching network comprises a series arrangement of at least one series resonant capacitor and the lamp output terminals, wherein the starting inductor and the starting capacitor form a resonant starting circuit having a starting resonant frequency which is about equal to a resonant frequency of a resonant drive circuit formed by the at least one series resonant capacitor and an inductance of the antenna of the lamp.

17. The power driver circuit of claim 9, wherein the lamp impedance matching network comprises a series arrangement of at least one series resonant capacitor and the lamp output terminals, wherein the starting inductor and the starting capacitor form a resonant starting circuit having a resonant frequency which is lower than a resonant frequency of a resonant drive circuit formed by the at least one series resonant capacitor and an inductance of the antenna of the lamp.

18. The power driver circuit of claim 9, wherein each one of the first switching element and the second switching element is a MOSFET having a gate coupled to a gate drive circuit, the gate drive circuit comprising:
a series arrangement of a gate drive inductor and a gate drive capacitor coupled between a first gate drive circuit terminal and a second gate drive circuit terminal, the first gate drive circuit terminal being coupled to the gate of the MOSFET;
a first gate drive switch coupled between the first gate drive circuit terminal and the second gate drive circuit terminal; and
a second gate drive switch coupled between the first drive circuit terminal and a DC power supply,
wherein the gate drive circuit further comprises a gate drive switch control circuit for controlling the switching of the first gate drive switch and the second gate drive switch, the gate drive switch control circuit being configured to switch the first gate drive switch and the second gate drive switch each on with a phase difference of 180 degrees and with a duty cycle of between about 0.1 and about 0.3.

19. The power driver circuit of claim 18, wherein the gate drive switch control circuit is configured to switch the first gate drive switch and the second gate drive switch each on with a frequency determined by a resonant frequency fₒ determined by an equivalent gate input capacitance, Cᵢₛₛ, an equivalent gate inductance, L_{g}, and an equivalent source inductance, Lₛ, of the MOSFET, and the gate drive inductor, L, according to the equation:
fₒ=1/(2·π·SQRT((L+L_{g}+Lₛ)·Cᵢₛₛ)),
wherein SQRT denotes a square root function.

20. The power driver circuit of claim 18, wherein the second terminal of the series arrangement is coupled to ground.

21. The power driver circuit of claim 18, wherein the second gate drive circuit terminal is coupled to a DC power supply.

22. A lighting unit comprising a power driver circuit of and an electrodeless lamp comprising an antenna winding having antenna terminals, wherein the lamp output terminals of the power driver circuit are connected to the antenna terminals of the lamp.

23. A method of operating the power driver circuit of claim 1, wherein the power supply terminals of the power driver circuit are connected to a DC power supply, and the lamp output terminals of the power driver circuit are connected to the antenna terminals of the lamp, the method comprising:
operating the DC power supply as a current source supplying a predetermined current, after the lamp has been ignited, and during a time period in which a DC power supply voltage ramps up to reach a predetermined value;
operating the DC power supply as a voltage source supplying a predetermined voltage, after said time period.

24. The method of claim 23, wherein during and after said time period, the DC power supply is operated at a fixed frequency.

25. A method of operating the power driver circuit of claim 17, wherein the power supply terminals of the power driver circuit are connected to a DC power supply, and the lamp output terminals of the power driver circuit are connected to the antenna terminals of the lamp, the method comprising:
operating the converter at the resonant frequency of the resonant starting circuit until the lamp is ignited, and subsequently
operating the converter at the resonant frequency of the resonant drive circuit.
